(19) United States
(12) Patent Application Publication
(10) Pub. No.: US 2019/0248390 A1
(43) Pub. Date: Aug. 15, 2019

(54) TRACK INTRUSION DETECTION SYSTEM

(71) Applicant: Hi-Tec Security Systems Ltd., Beit Elazari (IL)

(72) Inventor: David FRUCHT, Beit Elazari (IL)

(73) Assignee: Hi-Tec Security Systems Ltd., Beit Elazari (IL)

(21) Appl. No.: 16/275,642

(22) Filed: Feb. 14, 2019

Related U.S. Application Data
(60) Provisional application No. 62/630,857, filed on Feb. 15, 2018.

(51) Int. Cl. B61L 23/04; H04N 5/232; G06K 9/00; G01S 17/08; G01S 17/02

(52) U.S. Cl. CPC B61L 23/041; H04N 5/23299; G01S 17/023; G06K 9/00362; G01S 17/08; G06K 9/00771

(57) ABSTRACT

A track intrusion detection system for detecting the presence of human intruders in a path of a railway vehicle is disclosed. The track intrusion detection system includes at least one-track module for each entrance of a tunnel railway and a server. Each track module includes at least two sensors and a signal processing unit to indicate the presence of human intruders in the area scanned by the at least two sensors.

### CROSS-REFERENCE TO RELATED APPLICATIONS

This application claims the benefit of U.S. Provisional Patent Application No. 62/630,857, filed on Feb. 15, 2018, which is incorporated herein by reference in its entirety.

### FIELD OF THE INVENTION

The present invention relates generally to an intrusion detection system and methods thereof. More specifically, embodiments of the present invention relate to an intrusion detection and notification system designed to detect intrusion of an unauthorized human in an off-limits area, such as railway tracks.

### BACKGROUND OF THE INVENTION

Unauthorized entry onto railway tracks generally occurs either through platform gates or by jumping off a train platform. Intruders often climb over or around the platform gates. One solution is to install upgraded gates; however, gates alone are not able to stop people from simply jumping down from the platform and walking along the tracks into the tunnels.

Underground subway stations and tunnels present a difficult environment for conventional technologies such as motion detectors and video analytics to work effectively. Numerous variables including dim lighting, visual depth perception, moving shadows from train lights, heat, crowds, and passing trains pose complications for the way these technologies work,

Inappropriate alerts or false alarms may cause unnecessary disruption to train services, so the intrusion detection system must be robust and accurate to trigger an alarm whenever a valid human intrusion occurs.

### SUMMARY OF THE INVENTION

Some embodiments of the present invention relate to an intrusion detection and notification system designed to detect intrusion of an unauthorized human in an off-limits area, such as railway tracks. The system may comprise at least one track module for each entrance of a tunnel railway and a server. Each track module may comprise at least two sensors and a signal processing unit to indicate the presence of human intruders in the area scanned by the at least two sensors. The at least two sensors are stacked vertically above the path of the railway vehicle, and one of the two sensors is positioned at a lower height than the second one. The server is in communication with the track modules and is adapted to analyze data received from each track module and to detect if human intruders are in the path of the railway vehicle.

### BRIEF DESCRIPTION OF THE DRAWINGS

The subject matter regarded as the invention is described in detail and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is high level block diagram of the track intrusion detection system according to some embodiments;

FIG. 2 is high level block diagram of a track intrusion module according to some embodiments of the present invention; and

FIG. 3 is a schematic diagram illustrating the placement of the sensors within a track intrusion module.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

Some embodiments of the present invention are generally related to an intrusion detection system and methods thereof.

The value of the parameters specified all over the description are only examples, based on field tests.

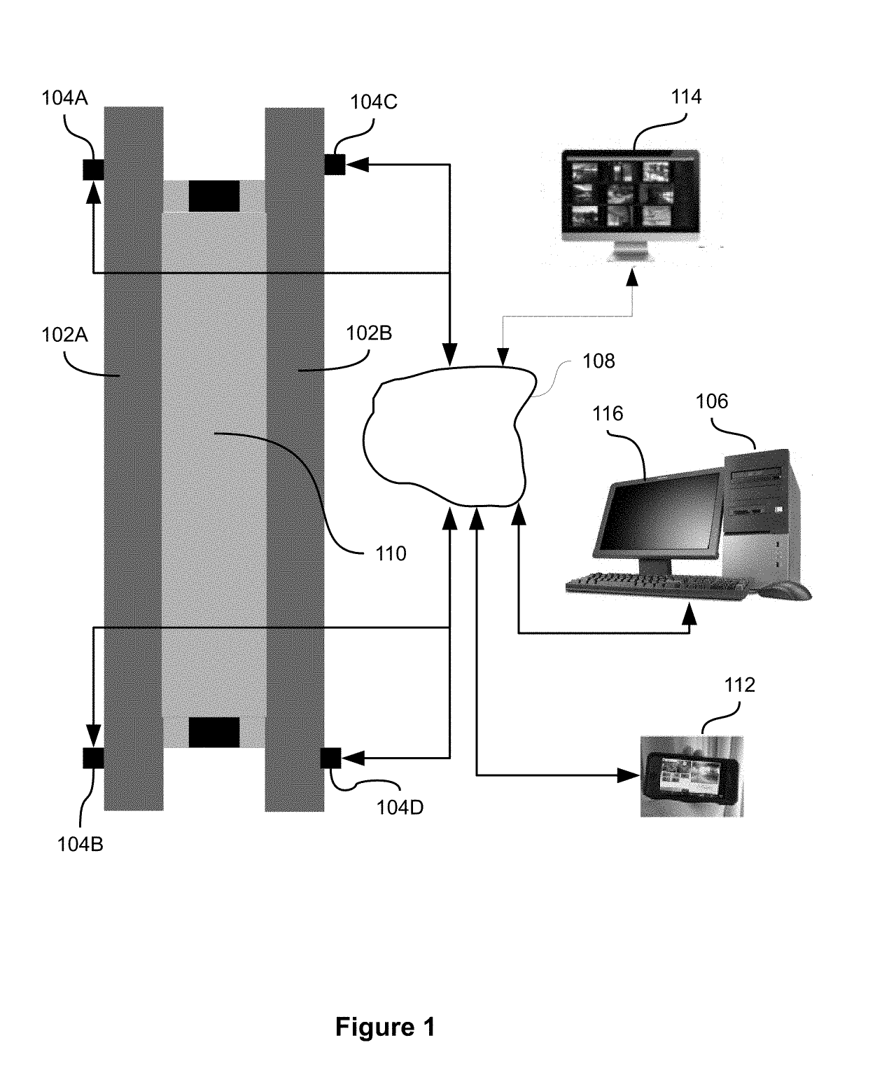

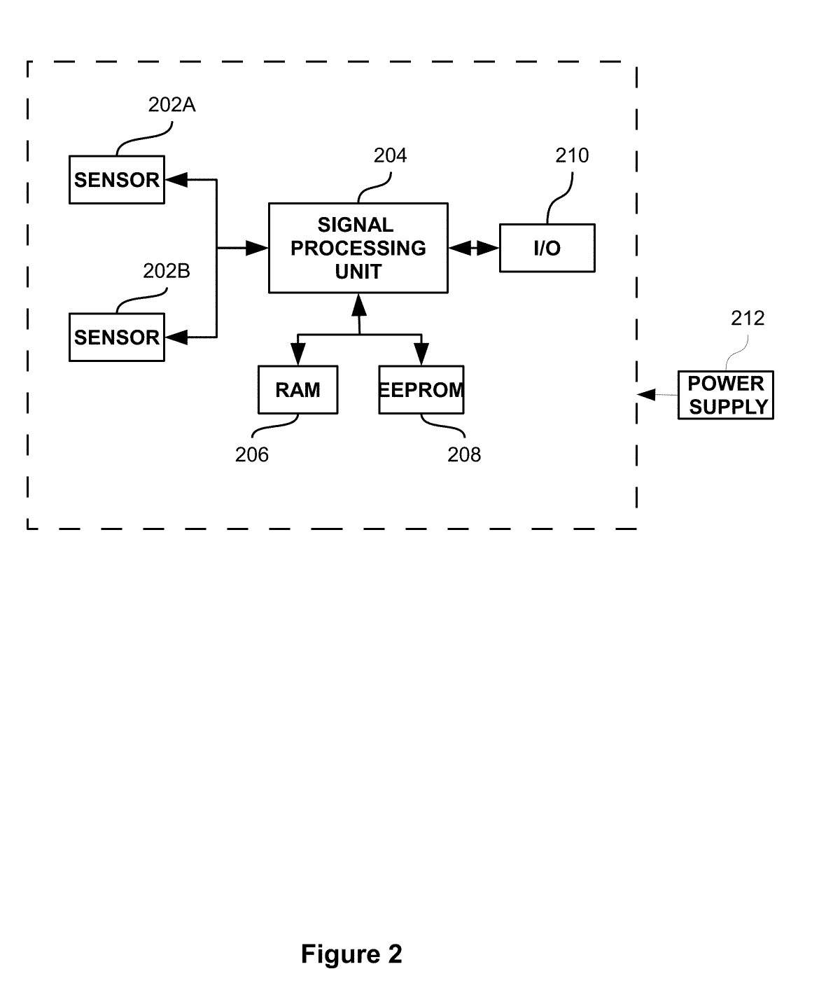

FIG. 1 depicts a high-level block diagram illustrating track intrusion system 100, in accordance with some embodiments of the present disclosure. In exemplary embodiments, where the station platform includes two tracks 102A and 102B, four track modules 104A-104D are installed (see FIG. 2 for more details on the track module), connected to network components either via a wired communication or a wireless connection, or the like. Each track module may provide outputs to a server 106 through an Internet Protocol (IP) interface, communicating through network 108. Although trains are described herein, some embodiments of the present disclosure may be used with any transportation system that utilizes a vehicle running on a track, rail, and/or the like to transport goods, passengers, and/or the like. Systems in accordance with some embodiments of the present disclosure may comprise any number of rails consistent with the system, for example, one, two, three, or four rails, or the like.

In accordance with exemplary embodiments, the design of a track intrusion detection system may generally depend on the placement of the track modules 104A-104D, near the track or in the train station, or the like, and analysis of the output data from the track modules 104A-104D. In an exemplary embodiment shown at FIG. 1, track modules may be installed at each end of a station platform 110, for a total of four track modules per platform.

Server 106 provides automated monitoring of all the track modules at a particular station platform 110. The server 106 is adapted to analyze the data received from the track modules 104A-104D to determine if human intruders are in the path of the railway vehicle.

According to some embodiments, server 106 may be adapted to activate an alarm or other warning mechanism when it is determined by the server 106 that human intruders are in the path of the railway vehicle (based on data information received from the track modules 104A-104D).

According to some other embodiments, server 106 may be assigned as a master server and provides monitoring of all stations equipped with track modules.

The placement of the track modules may provide redundant and overlapping detection areas, or the like, thereby providing full coverage of the intrusion areas where a person may intrude upon. The track intrusion detection system works both on the platform site and deep inside the tunnels to show where is the human intruder, if the human intruder returns back to the platform or continues deeper into the tunnel. The track intrusion system according to the present disclosure is not affected by approaching train headlights or low light conditions.

In some embodiments, IP video from track modules 102A-102D (see FIG. 2 for more details on the track modules) may be tied into a video management server (YSM) 114 for continuous recording.

In some embodiments, the intrusion detection system may be configured to communicate with remote devices 112, though network 108.

FIG. 2 depicts a high-level block diagram of a track intrusion module, in accordance with some embodiments of the present disclosure. According to this embodiment, each track module is a standalone sub-system which consists of two sensors 202A and 202B, and a signal processing unit 204. Signal processing unit 204 may detect the presence of human intruders in the area scanned by the two sensors and the distance of the human intruders from the track module in which the two sensors 202A and 202B are included.

According to some embodiments, the two sensors are lidar sensors, the laser used a class 1 control laser with a beam width of preferably 1 milliradian, which allows a search path radius of 100 meters, yet is safe for operation in the vicinity of humans.

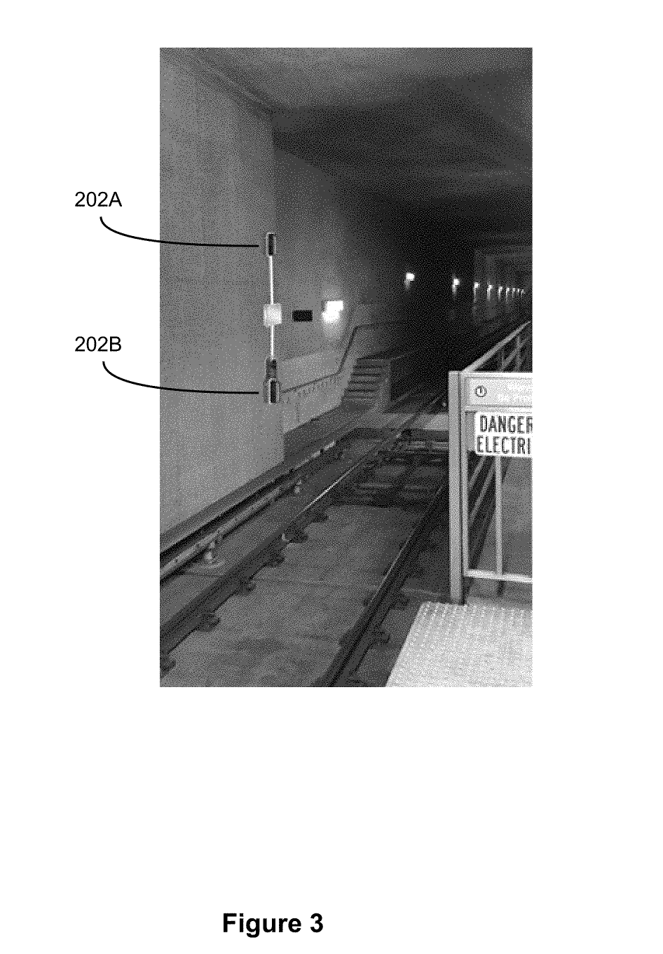

In accordance with exemplary embodiments, the design of a track intrusion detection system may generally depend on the placement of the two sensors 202A and 202B (see FIG. 3 for a more detailed illustration) and the output data from the two sensors 202A and 202B. In exemplary embodiments, the two sensors are being placed at different heights, and stacked vertically above the path of the railway vehicle. By way of example, the two sensors are stacked vertically approx. 3′ and 10′ above the rail, facing perpendicular to the track towards the platform, with clear view of the platform track area on one side and the tunnel on the opposite side. This enables the system to provide continuous tracking of intrusion activity from the platform extending into the tunnels and vice-versa. The sensors may provide a 180° detection corridor, preferably extending up to fifty meters in both directions from the end of the station platform to cover the track area in front of the station platform and extending into the tunnel.

According to some embodiment, the signal processing unit includes a computer and an algorithm for analysis of the signals to detect the presence of a human intruder in the area scanned by the two sensors, reduce the number of false alarms and calculate the distance of the human intruders from the track module in which the two sensors 202A and 202B are included. The following algorithm is an example of an algorithm and is not meant to be limiting in any way. A similar algorithm is detailed in U.S. Pat. No. 5,910,767. The first step in the detection process is the measurement of the time of flight of the signal from the sensor to object and back to the sensor. The time of flight determines the distance at each angle of the scanned sector, according to the sensor designated angular resolution. The principle of operation and description of the main parameters are as follows:

The sensor, at first few scans (hereinafter “FLIP” period), collects range statistics about each point. On the basis of this statistic, the algorithm creates a threshold of protected area, Consequently, the algorithm switches to detection mode, On detection mode, the algorithm detects points, in which range is transgress the bounds of the threshold, analyses them, and if all the criteria are satisfied, a human intruder is detected and an alarm may be generated The algorithm is adaptive to environmental changes and pliable for many kinds of detection configurations, e.g.: Offset—parameter which defines linear (distance) noise level; Delta—parameter which defines distance standard deviation of all successive points, falling out of threshold; Width—parameter, which defines minimal number of all successive points, that falling out of threshold multiplied by distance to target, needed to generate alarm; Order—parameter, which defines angular noise level; SST—scan to scan tracking its faculty of algorithm to prove right truth of the target, during number of scans; FLIP—parameter which defines number of scans in “learn” period (learning means building the map of the environment and its changing statistics); and SUN—parameter, which defines number of scans for adaptation to sunrise/sunset. The algorithm is also in charge with logic detection of humans and filtration out of trains. The algorithm correlates information from the two sensors about the size of the detected objects, location, features of the shape and timing.

Subsequently, the object features are analyzed and, if they pass the detection criteria, information data, e.g., the detection of human intruders, location of the intruders, the track module location are sent to the server 106.

In some embodiments, the track module is integrated with a 360° PTZ camera (not shown), with a native protocol a driver unit for pointing the PTZ camera to a point of interest in an area of interest. PTZ camera is driven by the sensors 202A and 202B of the track module to confirm detection and manually scan the tunnel.

In another embodiment, the signal processing unit is adapted to evaluate the data and the information gained from the PTZ camera and the two sensors 202A and 202B, and to automatically steer the PTZ camera to the location of the human intruders to confirm the detection and to provide an automated video tracking and transfer it to the server 108 and/or the VMS 114 (“slew to cue” capability).

According to some embodiments, the track intrusion detection system includes a display unit 116 to view the videos received from a track module and review indications sent by the track module.

According to some embodiments, the screen is based on black screen technology, and by so, the display unit 116 is configured to switch between an inactivated state corresponding to a black screen of the display unit, and in activated states in which a screen is displayed on the display unit when triggered by the indication of the human intruders sent by any track module. Each track module may provide outputs to a server 106 through an IP interface, communicating through network 108. The outputs to the server 106 may include different information data such as the track module number, the track module location, the station platform number, the location of the human intruders, time of the intrusion, videos captured by the PTZ camera.

According to some embodiments, the sensors are remotely software upgradeable, and remotely configurable.

According to some embodiments, hands-free operation provides operators with station name, track module location, and the operators are able to manually select any station of interest to view video and review alarms.

The track intrusion detection system may be capable of detecting up to sixteen human intruders simultaneously.

It should be noted that the method according to some embodiments of the present invention may be stored as instructions in a computer readable medium to cause processors, such as central processing units (CPU), to perform the method. Additionally, the method described in the present disclosure can be stored as instructions in a non-transitory computer readable medium, such as storage devices which may include hard disk drives, solid state drives, flash memories, and the like. Additionally, non-transitory computer readable medium can be memory units.

In order to implement the method according to some embodiments of the present invention, a computer processor may receive instructions and data from a read-only memory or a random-access memory or both. At least one of aforementioned steps is performed by at least one processor associated with a computer. The essential elements of a computer are a processor for executing instructions and one or more memories for storing instructions and data. Generally, a computer will also include, or be operatively coupled to communicate with, one or more mass storage devices for storing data files. Storage modules suitable for tangibly embodying computer program instructions and data include all forms of non-volatile memory, including by way of example semiconductor memory devices, such as EPROM, EEPROM, and flash memory devices and also magneto-optic storage devices.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object-oriented programming language such as Java, Smalltalk, JavaScript Object Notation (JSON), C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or portion diagrams of methods, apparatus (systems) and computer program products according to some embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram portion or portions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram portion or portions.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram portion or portions.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional elements.

It is to be understood that, where the claims or specification refer to “a” or “an” element, such reference is not be construed that there is only one of that elements.

It is to be understood that, where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A track intrusion detection system for detecting the presence of human intruders in a path of a railway vehicle, the system comprising:
at least one-track module for each entrance of a tunnel railway,
wherein the at least one-track module comprises at least two sensors, and a signal processing unit to indicate the presence of the human intruders in the area scanned by the at least two sensors, and
wherein the at least two sensors are stacked vertically above the path of the railway vehicle and a first of the at least two sensors is positioned at a lower height than a second of the at least two sensors,
at least one server in communication with the at least one-track module, the server comprising:
one or more processors; and
a memory;
wherein the at least one server is adapted to analyze data received from each of the at least one-track module to detect if human intruders are in the path of the railway vehicle.

2. The track intrusion detection system according to claim 1, wherein the at least one server is adapted to activate an alarm when it is determined by the server that human intruders are in the path of the railway vehicle.

3. The track intrusion detection system according to claim 1, wherein the at least two sensors are lidar sensors, adapted to detect the distance of the human intruders to the track module in which the at least two sensors are included.

4. The system according to claim 1, wherein the data received from each of the at least one-track module are in a form of Internet Protocol (IP) packets.

5. The track intrusion detection system according to claim 1, wherein said signal processing unit includes a computer, an algorithm to detect the human intruders and eliminate false positives from the railway vehicle.

6. The track intrusion detection system according to claim 1, wherein each of the least one track module further comprises a PTZ camera with a native protocol and a driver unit for pointing the camera to a point of interest in an area of interest, wherein the signal processing unit is further adapted to evaluate the data and the information gained from the PTZ camera and the at least two sensors and to automatically steer the PTZ camera to the location of the human intruders to confirm the detection and to provide an automated video tracking and transferring it to the at least one server.

7. The track intrusion detection system according to claim 6, wherein the at least one server further comprises a display unit to view the videos received from the at least one-track module and review the indications sent by the at least one-track module.

8. The track intrusion detection system according to claim 1, wherein the display unit is configured to switch between an inactivated state corresponding to a black screen of the display unit and an activated state in which a screen is displayed on the display unit when triggered by the indication of the human intruders sent by the at least one-track module.

9. The track intrusion system according to claim 1, wherein the system is configured to detect up to sixteen human intruders simultaneously.

10. The track intrusion system according to claim 1, wherein the at least two sensors are software upgradeable and remotely configurable.

11. The track intrusion system according to claim 1, wherein continuous plotting of the human intruders on a station map is displayed on the screen when the display unit is in activated state.
